(19) United States
(12) Patent Application Publication
(10) Pub. No.: US 2007/0004903 A1
(43) Pub. Date: Jan. 4, 2007

(54) Method for the separation of monomers from a composition containing a monomer

(76) Inventors: Andreas Hoff, Dortmund (DE); Axel Kobus, Langen (DE); Dennis Thong, Marl (DE); Ralf Goedecke, Rodenbach (DE); Martin Roos, Haltem (DE); Torsten Balduf, Houston, TX (US)

Correspondence Address: SMITH MOORE LLP, P.O. BOX 21927, GREENSBORO, NC, 27420, US

(21) Appl. No.: 10/551,050

(22) PCT Filed: Mar. 26, 2004
(86) PCT No.: PCT/EP04/03211

§ 371 Date: Sep. 8, 2006

(30) Foreign Application Priority Data
Mar. 28, 2003 (DE) 103142037

(51) Int. Cl. C08F 6/00

(52) U.S. Cl. 528/480

(57) ABSTRACT

The present invention concerns a process for separation of a monomer including at least one double bond, hereafter referred to as “monomer,” in particular (meth)acrylic acid, from a composition Z including this monomer and at least one impurity different to the monomer, including the steps of bringing into contact of the composition Z with an additive by forming a separation phase. The additive has a melting point of at most about 150° C. and a vapour pressure at a temperature of 20° C. of at most about 1 mbar. The monomer is then separated from the separation phase. A device for producing a monomer, the use of additives in the separation of a monomer from a monomer-comprising composition, the monomer obtainable by the process according to the invention, chemical products comprising the monomer as well as the use of the monomer in or for production of chemical products.

This application is a national stage application under 35 U.S.C. 371 of international application No. PCT/EP2004/003211 filed Mar. 26, 2004, which is based on German Application No. DE 103 14 203.7 filed Mar. 28, 2003, and claims priority thereto.

### BACKGROUND OF THE INVENTION

The present invention concerns a process for separation of a monomer comprising at least one double bond, referred to herein as a “monomer” in the following, in particular (meth)acrylic acid, from a monomer-comprising composition, a device for producing a monomer, the use of additives for separation of a monomer from a monomer-comprising composition, the monomers obtainable by the process according to the invention, chemical products comprising this monomer and the use of this monomer in or for production of chemical products.

The monomer according to the invention are monomers familiar to the person skilled in the art, which are used in synthesis of synthetic materials. The monomers have a molecular weight in the range of from about 28 to about 300 g/mol, preferably from about 30 to about 250 g/mol and particularly preferably from about 70 to about 200 g/mol. Into this category fall, on the one hand, CH-monomers comprising only hydrocarbons, preferably styrene, a-methylstyrene, and on the other hand, CHO/N-monomers comprising, besides carbon and hydrogen, also oxygen or nitrogen or both, preferably (meth)acrylic acid, butylacrylate, acrylonitrile as well as acrylamide, wherein (meth)acrylic acid is preferred. (Meth)acrylic acid is used in this text for the compounds with nomenclature names “methacrylic acid” and “acrylic acid”. Of the two compounds, acrylic acid is preferred according to the invention.

Acrylic acid is frequently obtained by catalytic vapour phase oxidation of propylene with an oxygen-comprising gas. Thus, in a two-step process the propylene is first catalytically oxidized to acrolein, which is then in a second process step converted into acrylic acid, likewise by use of catalysts (see, e.g. DE-A-19 62 431, DE-A-29 43 707, EP-A-257 565, WO 99/14181 A1). The synthesis of methacrylic acid occurs comparably by catalytic oxidation of iso-butylene, tert-butanol, methacrolein or isobutylaldehyde in the gas phase.

In the synthesis of monomers such as in the catalytic oxidation of propylene or isobutylene in the gas phase, however, besides the (meth)acrylic acid are generated quantities of by-products, which prevent direct further processing, since the synthetic material obtained would be insufficiently pure for use in further processing products. In the case of the oxidation of propylene in the gas phase, in particular acetic acid, propionic acid and aldehydes as well as water are among the by-products occurring as impurities.

A (meth)acrylic acid which is as pure and free from by-products as possible is, however, desired. For example, acrylic acid in the form of cross-linked, water absorbing polyacrylates is used in articles intended for absorption of body fluids. These are above all diapers, which are used for babies, infants and adult incontinence, and feminine hygiene articles, which are used in the context of menstruation. All applications of these articles have in common, that the article is used in contact with the skin for a comparable length of time, generally several hours. Since body fluids are absorbed by these articles, they furthermore remain over this long period of time in liquid contact with the skin or with mucous membranes. For this reason, the toxicological demands made on polymers based on polyacrylates are very high. In the production of polyacrylates only high purity starting materials, in particular only highly pure acrylic acid, can be used.

In order to obtain high purity (meth)acrylic acid, it is therefore a question of processing the gaseous oxidation products obtained in the process for producing (meth)acrylic acid to the effect that the (meth)acrylic acid is separated as selectively as possible to obtain high purity (meth)acrylic acid.

In particular with respect to the separation of acrylic acid from the gaseous oxidation products, numerous different processes are described in the art.

It is known from DE-A-21 36 396 to separate the acrylic acid from the reaction gases obtained from catalytic oxidation of propylene or acrolein by counter-flow absorption with a mixture of 75 wt. % diphenylether and 25 wt. % diphenyl. The cooling of the hot reaction gas by partial evaporation of the solvent in a direct condenser (quench apparatus) before the counter-flow absorption is further known from DE-A-24 49 780.

Besides the absorption of the reaction product comprising the acrylic acid in a high boiling solvent, other known processes provide a total condensation of the reaction water likewise generated in the catalytic oxidation. Thus, an aqueous acrylic acid solution is produced, which, by distillation with an azeotrope (JP 11 24 766, JP 71 18 766) or by extraction processes (DE-A-21 64 676), which can optionally be followed by a crystallization (WO 99/14181 A1), can be further processed.

Independent of the type of presently described process for separation of acrylic acid from the reaction gases, the purity of the thus obtained acrylic acid is generally insufficient to be able to use it immediately in the production of superabsorbers based on cross-linked polyacrylates. In the further processing into polyacrylates, particularly troublesome are maleic acid, oligomers, acetic acid, propionic acid or aldehydes as well as water, individually or mixtures thereof.

A separation of the (meth)acrylic acid from the (meth)acrylic acid-comprising solvent mixtures obtainable from the counter-flow absorption or from the aqueous (meth)acrylic acid solutions obtained by total condensation, and the thereto-linked separation of the (meth)acrylic acid from the by-products, are possible by distillation processes, by crystallization processes or by combinations of these processes (see e.g. also DE-A-196 00 955). By means of simple distillation processes, however, by-products with similar boiling points, in particular propionic acid (b.p. propionic acid: 140.9° C.; b.p. acrylic acid: 141.6° C.), cannot be separated. A satisfactory purity of the (meth)acrylic acid is often not achievable by crystallization processes comprising one crystallization step. Additionally, a eutectic composition can be obtained during crystallization, from which the separation of the (meth)acrylic acid from the by-products generated as impurities by crystallization is not or only with difficulty possible.

U.S. Pat. No. 4,230,888 further teaches a process for purification of acrylic acid by crystallization in the presence of common salt, wherein the eutectic point is influenced by addition of common salt. A disadvantage is the fact that the common salt must be added as a solution and thus by means of the solvent a further undesired component is introduced into the system to be separated. Additionally, the common salt can at higher concentrations precipitate with the crystallized acrylic acid and thereby lead to an undesired multiphase solid-liquid mixture. In this mixture common salt crystals are present besides the acrylic acid crystals, so that a separation of two solids must occur. A separation is very laborious. In addition, the use of common salt is disadvantageous owing to its highly corrosive effect.

WO 02/074718 discloses the use of ionic liquids in a distillation process for separation of mixtures with similar boiling points. Because of the low thermal stability of monomers a distillative processing of monomers is generally accompanied by formation of undesired reaction products of the monomers or leads, because of a spontaneously occurring polymerization, to undesired interruptions in the processing of monomers.

The present invention therefore has the object of overcoming the disadvantages arising from the state of the art of the processes for selective separation of respectively monomers or (meth)acrylic acid from respectively monomer- or (meth)acrylic acid-comprising compositions.

A further object of the present invention is in particular to make available a process with which a monomer can be separated, with a desired purity, from a monomer-comprising composition, as selectively and efficiently as possible, in as few separation steps as possible, without unnecessary operational interruptions.

A further object of the present invention is to make available a device with which a monomer can be separated, with a desired purity, from a monomer-comprising composition, as selectively and efficiently as possible, in as few separation steps as possible, without unnecessary operational interruptions.

Another object of the invention is to provide a monomer which has an as high as possible degree of purity.

An additional object according to the invention is that in the separation of a monomer from a monomer-comprising composition, the impurities contained besides the monomer in the monomer-comprising composition are depleted as consistently and invariably as possible in the monomer obtained after the separation.

A further object of the invention is to make available aqueous monomer phases, in particular aqueous acrylic acid solutions, which have an increased purity of the monomer or the acrylic acid respectively with increasing water content. Aqueous acrylic acid solutions of this type are of particular interest for solution, emulsion or suspension polymerization for production of water-absorbing, hydrogel-forming polymers. Until now, in the production of these polymers, high purity, water-free acrylic acid obtained by distillation was first mixed with water, in order to be introduced into the polymerization process as an aqueous acrylic acid solution.

### BRIEF DESCRIPTION OF THE DRAWINGS

FIG. 1 shows a device for synthesis of (meth)acrylic acid, which comprises a recycling unit for the additive.

FIG. 2 shows a schematic of an arrangement variant of the device according to the invention.

FIG. 3 is a graphic depiction of the values from Table 8.

### DETAILED DESCRIPTION OF THE INVENTION

These objects are solved by a process for separation of a monomer from a monomer-comprising composition, as well as by a device for carrying out this process, by the use of additives in the separation of a monomer from a monomer-comprising composition, by the monomers obtainable by the process according to the invention, as well as by fibers, formed bodies, films, foams, superabsorbing polymers, special polymers for the areas of waste water treatment, dispersion dyes, cosmetics, textiles, leather processing or paper manufacture or hygiene articles, at least based on the monomer according to the invention, as well as the use of the monomer according to the invention in fibers, formed bodies, films, foams, superabsorbing polymers, special polymers for the areas of waste water treatment, dispersion dyes, cosmetics, textiles, leather processing or paper manufacture or hygiene articles.

The process according to the invention for separation, preferably for selective separation, of a monomer comprising at least one, preferably only one, double bond from a composition Z comprising this monomer and at least one impurity different to this monomer comprises the process steps:
bringing the composition Z into contact with an additive, wherein the additive has
   a melting point determined according to the herein described test methods of at most about 150° C., preferably at most about 125° C. and particularly preferably at most about 100° C., wherein however the melting point is preferably not below about −80° C., particularly preferably not below about −60° C. and further preferred not below about −55° C., and
   a vapour pressure determined according to the herein described test methods of at most about 1 mbar, preferably at most about 0.1 mbar, particularly preferably at most about 0.01 mbar and further preferred at most about 0.001 mbar at a temperature of about 20° C.,
      to form a separation phase
separation of the monomer from this separation phase.

The monomer according to the invention is a monomer familiar to the skilled person, which are used in synthesis of synthetic materials. The monomers have a molecular weight in the range of from about 28 to about 300 g/mol, preferably from about 30 to about 250 g/mol and particularly preferably from about 70 to about 200 g/mol. Into this category fall on the one hand CH-monomers comprising only hydrocarbons, preferably styrene, α-methylstyrene, and on the other hand CHO/N-monomers comprising oxygen or nitrogen or both in addition to carbon and water, preferably (meth)acrylic acid, butylacrylate, acrylonitrile and acrylamide, wherein (meth)acrylic acid is preferred. (Meth)acrylic acid is used in this text for compounds with the nomenclature names “methacrylic acid” and “acrylic acid.” Of the two compounds, acrylic acid is preferred according to the invention. Besides the CHO/N monomers, preferred monomers are those which have, in addition to a CC double bond, an acidic group or a salt thereof or a derivative of an acidic group such as an ester, preferably an acidic group or a salt thereof. Preferred in this category are (meth)acrylic acid or salts thereof, methyl methacrylate, methyl acrylate or butyl acrylate, wherein (meth)acrylic acid is particularly preferred.

All substances forming during the monomer synthesis or also during the processing of the monomer, which are different to the monomer, can be considered as impurities. Impurities forming during the processing are, besides water, organic compounds, in particular organic compounds to which the monomer binds or preferably in which the monomer dissolves during the processing, preferably in the quenching step. A particularly preferred impurity is water.

In a preferred embodiment of the process according to the invention, an additive comprising, preferably substantially composed of, at least
i. an ionic liquid or
ii. a highly branched polymer, preferably a hyperbranched polymer or
iii. a mixture of at least two thereof
   is used.
   i. Ionic Liquids

The term “ionic liquids” according to the invention should be taken to mean a salt, preferably an organic salt with a melting point of less than about 100° C., particularly preferably an organic salt, which is available in liquid state under ambient conditions (about 20° C., about 1013 mbar).

In general, ionic liquids are distinguished by favourable properties, in particular in respect of a potential use as solvent, and are regarded as a new class of innovative solvent. Because of the high boiling points, under moderate conditions ionic liquids have almost no vapour pressure together with relatively low liquid viscosities, so that simplified product processing and higher purities can be achieved by means of ionic liquids, and little or no trace of ionic liquids is found in the processed products. In addition, ionic liquids present, by means of their combinatorial diversity, which arises from the variation of anion and cation, a particularly flexible solvent concept, which can be precisely adapted to the technical problem to be solved by the choice of suitable combinations and concentrations. In the context of suitably ionic liquids according to the invention, reference is made to WO 02/074718 A2, in particular pages 3 to 14. Furthermore, according to the invention, mixtures of ionic fluids are considered, such as those offered by Scionix Ltd., UK, among others. Reference is further made in this context to the disclosure in Aldrichimica Acta Vol. 35, No. 3, p. 75-83, 2002.

Ionic fluids preferred according to the invention comprise as cation an organic compound comprising a nitrogen atom or a phosphorus atom. Particularly preferred cations are selected from the group consisting of:
A. imidazolium ions
B. pyridinium ions
C. ammonium ions or
D. phosphonium ions,
   whose structures are represented as follows:

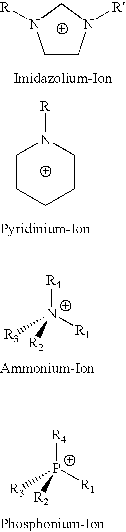

Preferred imidazolium ions, pyridinium ions, ammonium ions or phosphonium ions are those for which the R groups R, R′, R₁, R₂, R₃ and R₄ are linear or branched, saturated or unsaturated, preferably saturated hydrocarbons or polyoxyalkylenes, preferably hydrocarbons with from 1 to about 40, particularly preferably with from about 1 to about 30 and further preferred with from 1 to about 10 carbon atoms. Particularly preferred groups R, R′, R₁, R₂, R₃ and R₄ are selected independently from each other from the groups comprising methyl group, ethyl, iso-propyl groups, n-propyl, n-butyl, iso-butyl, tert-butyl, n-hexyl, cyclohexyl, heptyl, octyl, nonyl and pentyl groups, wherein methyl group, ethyl, iso-propyl groups, n-propyl, n-butyl, isobutyl, tert-butyl, n-hexyl or cyclohexyl groups are particularly preferred. These hydrocarbon groups can in turn have further functional groups, with which the desired properties of an ionic liquid can be adjusted.

Besides these cations, the alkali metal cations Na⁺ and K⁺ are preferred cations, whereby of these, Na⁺ is particularly preferred.

As anions, the ionic liquids preferred according to the invention comprise preferably anions selected from the group consisting of halogens, sulphate, acetate, trifluoroacetate, halogen aluminate, halogen borate, halogen antimonite, nitrate, copper halide, tin halide, aluminium alkylhalide, alkyl sulfite, carboxylate or trialkylborate.

Particularly preferred anions are anions selected from the group consisting of:
a. Cl⁻
b. AlCl₄⁻
c. Al₂Cl₇⁻
d. Al₃Cl₁₀⁻
e. BCl₄⁻
f. BF₄⁻
g. PF₆⁻
h. SbF₆⁻
i. NO₃⁻
j. HSO₄⁻
k. CH₃COO⁻
l. CF₃COO⁻
m. CF₃SO₃⁻
n. (CF₃SO₂)₂N⁻
o. CuCl₂⁻
p. Cu₂Cl₃⁻
q. Cu₃Cl₄⁻
r. SnCl₃⁻
s. Sn₂Cl₅⁻
t. AlEtCl₃⁻
u. Al₂Et₂Cl₅⁻
v. n-C₄F₉SO₃⁻
w. C₃F₇COO⁻
x. CH₃—C₆H₄—SO₂⁻
y. Et₂(C₆H₁₃)B⁻.

Each conceivable pair wise combinations of one cation denoted above by a capital letter and an anion denoted by a small letter gives an embodiment according to the invention of the process according to the invention, in which ionic liquids are used. Preferred embodiments of the process according to the invention are the processes in which ionic liquids are used, which comprise the following combinations of ions:

Aa, Ab, Ac, Ad, Ae, Af, Ag, Ah, Ai, Aj, Ak, Al, Am, An, Ao, Ap, Aq, Ar, As, At, Au, Av, Aw, Ax, Ay, Ba, Bb, Bc, Bd, Be, Bf, Bg, Bh, Bi, Bj, Bk, Bl, Bm, Bn, Bo, Bp, Bq, Br, Bs, Bt, Bu, By, Bw, Bx, By, Ca, Cb, Cc, Cd, Ce, Cf, Cg, Ch, Ci, Cj, Ck, Cl, Cm, Cn, Co, Cp, Cq, Cr, Cs, Ct, Cu, Cv, Cw, Cx, Cy, Da, Db, Dc, Dd, De, Df, Dg, Dh, Di, Dj, Dk, Dl, Dm, Dn, Do, Dp, Dq, Dr, Ds, Dt, Du, Dv, Dw, Dx, Dy.

Among these ionic liquids those particularly preferred are those whose structures are depicted as follows:

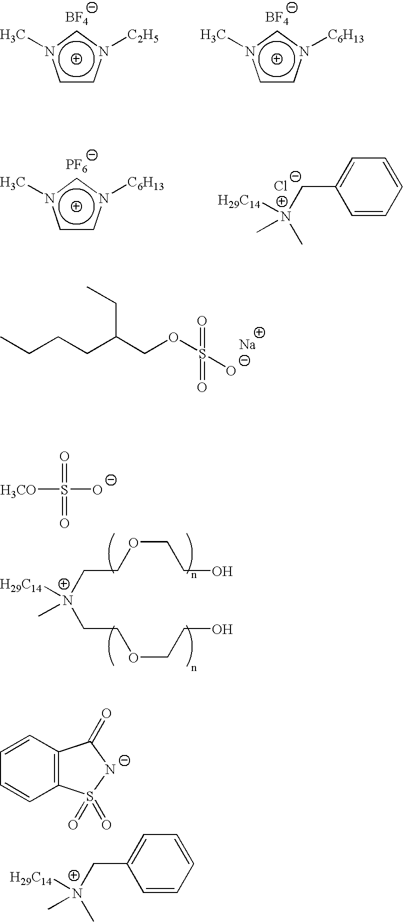

The above-described ionic liquids can be used as additive alone or as a mixture of at least two different ionic liquids in the process according to the invention. Further ionic liquids preferred according to the invention as well as processes for their production are described in Angewandte Chemie, 2000, 112, p. 3926-3945.

The ionic liquids preferably used in the process according to the invention comprise at least one cation of the general formulae:
R¹R²R³R⁴N⁺ (1)
R¹R²N⁺═CR³R⁴ (2)
R¹R²R³R⁴P⁺ (3)
R¹R²P⁺═CR³R⁴ (4)
in which
R¹, R², R³, R⁴ are the same or different and denote hydrogen, a linear or branched, optionally double bond-comprising aliphatic hydrocarbon residue with from 1 to about 30 carbon atoms, a cyclic aliphatic optionally double bond-comprising hydrocarbon residue with from about 5 to about 40 carbon atoms, an aromatic hydrocarbon residue with from about 6 to about 40 carbon atoms, an alkylaryl residue with from about 7 to about 40 carbon atoms, a linear or branched aliphatic hydrocarbon residue with from about 2 to about 20 carbon atoms interrupted by one or more hetero-atoms (oxygen, NH, NR′ with R′ an optionally double bond-comprising C₁ to C₃₀ alkyl residue, in particular CH₃), a linear or branched, optionally double bond-comprising, aliphatic hydrocarbon residue with from about 2 to about 30 carbon atoms interrupted by one or more functionalities selected from the group —C(O)—, —(O)C—O—, —NH—C(O)—, —(O)C—NH—, —(CH₃)N—C(O)—, —(O)C—N(CH₃)—, —S(O₂)—O—, —O—S(O₂)—, —S(O₂)—NH—, —NH—S(O₂)—, —S(O₂)—N(CH₃)—, —N(CH₃)—S(O₂)—, a terminal OH, OR′, NH₂, N(H)R′, N(R′)₂ with R′ an optionally double bond-comprising from C₁ to about C₃₀ alkyl residue, functionalized linear or branched, optionally double bond-comprising aliphatic or cyclic aliphatic hydrocarbon residues with from 1 to about 30 carbon atoms or a block-wise or statistically composed polyether according to —(R⁵—O)ₙ—R⁶,
   wherein
   R⁵ is a from about 2 to about 4 carbon atom-comprising linear or branched hydrocarbon residue,
   n is from 1 to about 100, preferably from about 2 to about 60, and
   R⁶ represents hydrogen, a linear or branched, optionally double bond-comprising aliphatic hydrocarbon residue with from 1 to about 30 carbon atoms, a cyclic aliphatic optionally double bond-comprising hydrocarbon residue with from about 5 to about 40 carbon atoms, an aromatic hydrocarbon residue with from about 6 to about 40 carbon atoms, an alkylaryl residue with from about 7 to about 40 carbon atoms or a residue —(O)—R⁷ with
   R⁷ being a linear or branched aliphatic, optionally double bond-comprising hydrocarbon residue with from 1 to about 30 carbon atoms, a cyclic aliphatic, optionally double bond-comprising hydrocarbon residue with from about 5 to about 40 carbon atoms, an aromatic hydrocarbon residue with from about 6 to about 40 carbon atoms, an alkylaryl residue with from about 7 to about 40 carbon atoms.

Ions which can be used as cations are those derived from saturated or unsaturated cyclic compounds as well as from aromatic compounds with respectively at least one trivalent nitrogen atom in a from 4- to 10-, preferably from 5- to 6-membered heterocyclic ring, which can optionally be substituted. Such cations can be more simply described (i.e. without giving the exact position and number of double bonds in the molecule) by the general formulae (5), (6) and (7) below, wherein the heterocyclic rings can optionally contain also more heteroatoms: 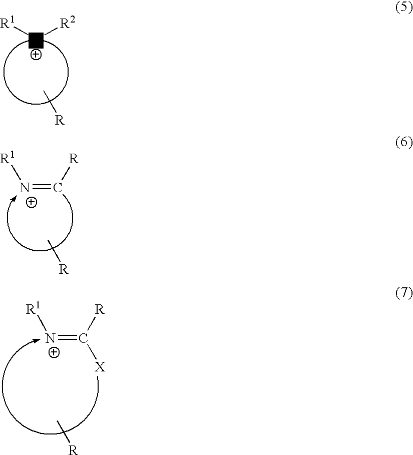
R¹ and R² have the above meaning,
R is a hydrogen, a linear or branched aliphatic, optionally double bond-comprising hydrocarbon residue with from 1 to about 30 carbon atoms, a cyclic aliphatic, optionally double bond-comprising hydrocarbon with from about 5 to about 40 carbon atoms, an aromatic hydrocarbon residue with from about 6 to about 40 carbon atoms or an alkylaryl residue with from about 7 to about 40 carbon atoms and
X is an oxygen atom, a sulphur atom or a substituted nitrogen atom (X=O, S, NR′).

Examples of cyclic nitrogen compounds of the above type are pyrrolidine, dihydropyrrole, pyrrole, imidazoline, oxazolonine, oxazole, thiazoline, thiazole, isoxazole, isothiazole, indole, carbazole, piperidine, pyridine, the isomers picoline and lutidine, quinoline and iso-quinoline. The cyclic nitrogen compounds of the general formulae (5), (6) and (7) can be unsubstituted (R=H), singly or multiply substituted by the residue R, whereby in the case of a multiple substitution by R the individual R groups can be different.

Ions which can be used as cations are those derived from saturated acyclic, saturated or unsaturated cyclic compounds as well as from aromatic compounds with respectively more than one trivalent nitrogen atom in a from 4- to 10-, preferably from 5- to 6-membered heterocyclic ring. These compounds can be substituted at the carbon atoms as well as at the nitrogen atoms. They can furthermore be annelated by formation of polynuclear structures by means of optionally substituted benzene rings and/or cyclohexane rings. Examples of such compounds are pyrazole, 3,5-dimethylpyrazole, imidazole, benzimidazole, n-methylimidazol, dihydropyrazole, pyrazolidine, pyridazine, pyrimidine, pyrazine, 2,3-, 2,5- and 2,6-dimethylpyrazine, cimoline, phthalazine, quinazoline, phenazine and piperazine. In particular cations of the general formula (8) derived from imidazole and its alkyl and phenyl derivatives have proven themselves as components of ionic liquids.

Further ions which can be used as cations contain two nitrogen atoms and are given by the general formula (8) 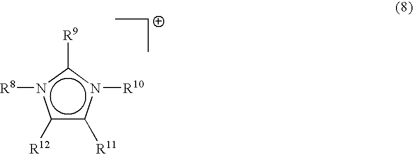
in which
R⁸, R⁹, R¹⁰, R¹¹, R¹² are the same or different and represent hydrogen, a linear or branched, optionally double bond-comprising aliphatic hydrocarbon residue with from 1 to about 30 carbon atoms, a cyclic aliphatic, optionally double bond-comprising hydrocarbon residue with from about 5 to about 40 carbon atoms, an aromatic hydrocarbon residue with from about 6 to about 40 carbon atoms, an alkylaryl residue with from about 7 to about 40 carbon atoms, a linear or branched, optionally double bond-comprising aliphatic hydrocarbon residue with from 1 to about 30 carbon atoms interrupted by one or more hetero-atoms (oxygen, NH, NR′ with R′ an optionally double bond-containing from C₁ to about C₃₀ alkyl residue), a linear or branched, optionally double bond-comprising, aliphatic hydrocarbon residue with from 1 to about 30 carbon atoms interrupted by one or more functionalities selected from the group —O—C(O)—, —(O)C—O—, —NH—C(O)—, —(O)C—NH—, —(CH₃)N—C(O)—, —(O)C—N(CH₃)—, —S(O₂)—O—, —O—S(O₂)—, —S(O₂)—NH—, —NH—S(O₂)—, —S(O₂)—N(CH₃)—, —N(CH₃)—S(O₂)—, a terminal OH, OR′, NH₂, N(H)R′, N(R′)₂ with R′ a from C₁ to about C₃₀, optionally double bond-comprising alkyl residue, functionalised linear or branched, optionally double bond-comprising, aliphatic or cyclic aliphatic hydrocarbon residues with from 1 to about 30 carbon atoms or a block-wise or statistically composed polyether composed of —(R⁵—O)ₙ—R⁶,
   wherein
   R⁵ represents a from about 2 to about 4 carbon atom-comprising hydrocarbon residue,
   n is from 1 to about 100 and
   R⁶ represents hydrogen, a linear or branched, optionally double bond-comprising aliphatic hydrocarbon residue with from 1 to about 30 carbon atoms, a cyclic aliphatic, optionally double bond-comprising hydrocarbon residue with from about 5 to about 40 carbon atoms, an aromatic hydrocarbon residue with from about 6 to about 40 carbon atoms, an alkylaryl residue with from about 7 to about 40 carbon atoms or a residue —C(O)—R⁷ with
   R⁷ being a linear or branched, optionally double bond-comprising aliphatic hydrocarbon residue with from 1 to about 30 carbon atoms, a cyclic aliphatic, optionally double bond-comprising hydrocarbon residue with from about 5 to about 40 carbon atoms, an aromatic hydrocarbon residue with from about 6 to about 40 carbon atoms, an alkylaryl residue with from about 7 to about 40 carbon atoms.

The ionic fluids preferably used according to the invention comprise at least one of the above-mentioned cations combined with respectively an anion. Preferred anions are selected from the group—without claim to completeness—halides, bis(perfluoroalkylsulfonyl)amides, alkyl- and aryltosylates, perfluoroalkyltosylates, nitrates, sulfates, hydrogensulfates, alkyl- and arylsulfates, polyethersulfates and -sulfonates, perfluoroalkylsulfates, sulfonates, alkyl- and arylsulfonates, perfluorinated alkyl- and arylsulfonates, alkyl- and arylcarboxylates, perfluoroalkylcarboxylates, perchlorates, tetrachloroaluminates, saccharinates. Further preferred anions are dicyanamide, tetrafluoroborate, hexafluorophosphate, polyether phosphates and phosphate.

It is further preferred that the ionic liquids used in the process according to the invention preferably have a viscosity according to DIN 53 019 at 20° C. in a range from about 1 to about 10,000 mPa×sec, preferably from about 2 to about 5,000 mPa×sec, particularly preferably in a range from about 5 to about 1,000 mPa×sec and further preferred in a range from about 10 to about 500 mPa×sec. It is further preferred that at a temperature of 20° C. the ionic liquids are liquid and have a viscosity of less than about 1,000 mPa×sec, particularly less than about 500 mPa×sec and further preferred less than about 100 mPa×sec.

ii. Highly Branched Polymers

The term “respectively hyper or highly branched polymers” is understood to be a class of innovative materials, which are characterized by an optionally irregularly formed globular molecular structure and by a large number of functional groups in the molecule. The high degree of branching in the molecular design leads to a particular combination of properties, such as for example low melting or solution viscosity respectively as well as an excellent solubility behaviour compared to numerous solvents.

The highly branched, globular polymers are also described in the specialist literature as “dendritic polymers”. These dendritic polymers can be divided into two different categories, the “dendrimers” and the “hyper-branched polymers.” Dendrimers are highly regular, three-dimensional, monodisperse polymers with a tree-like, globular structure. Their structure is characterized by three distinguishable areas: by a polyfunctional central nucleus, which represents the symmetrical centre, different, well-defined radially symmetrical layers of a repeating unit and the end groups. The hyper-branched polymers are, in contrast to the dendrimers, polydisperse and irregular in respect of their branching and structure. An example of respectively a dendrimer and a highly branched polymer, composed of repeating units, which have respectively three possible binding sites, is shown in the following structures:

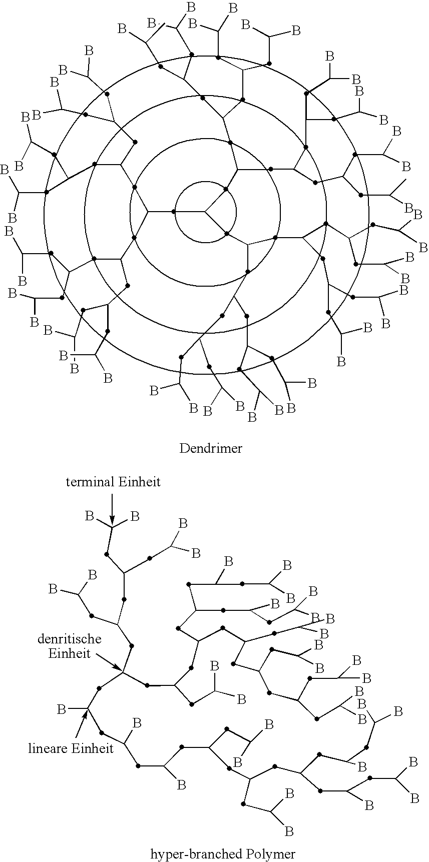

With respect to the various possibilities for synthesis of the dendrimers and hyper-branched polymers, reference is made to Chem. Eng. Technol. 2002, 25, p. 237-253. The highly branched polymers described in this article are also preferred highly branched polymers in the sense of the present invention.

Hyper-branched polymers are preferably used as highly branched polymers in the process according to the invention. In this context it is preferred that the hyper-branched polymers have at least about 3 repeating units per molecule, preferably at least about 10 repeating units per molecule, further preferred at least about 100 repeating units per molecule, additionally preferred at least about 200 repeating units per molecule and even more preferred at least about 400 repeating units, which have respectively at least about 3, preferably at least about 4 possible binding sites, wherein at least about 3 of these repeating units, particularly preferably at least about 10 and even more preferably at least about 20 are bound by means of at least about 3, preferably at least about 4 possible binding sites with at least about 3, preferably at least about 4 other repeating units. The hyper-branched polymers have a maximum of about 10,000, preferably a maximum of about 5000 and particularly preferably a maximum of about 2500 repeating units.

In a preferred embodiment, the highly branched polymer has at least about 3 repeating units per molecule, which have respectively at least about 3 possible binding sites, wherein at least about 3 of said repeating units have at least about 2 possible binding sites.

The term “repeating unit” should be interpreted preferably as meaning a constantly recurring structure within the hyper-branched molecule. The term “possible binding site” is preferably understood to be each functional structure within a repeating unit with which a link to another repeating unit is possible. With respect to the above presented examples of a dendrimer or hyper-branched polymer respectively, the repeating unit is a structure with respectively about 3 possibly binding sites (X, Y, Z):

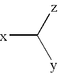

The linking of the individual binding units together can occur by condensation polymerization, by radical polymerization, by anionic polymerization, by cationic polymerization, by group transfer polymerization, by coordinative polymerization or by ring-opening polymerization.

Particularly preferred hyper-branched polymers are polymers for which the binding units have about 2 possible binding sites. In this context preferred hyper-branched polymers are polyglycerines, polyesters and polyesteramides. Of these polymers, particularly preferred are those obtainable commercially under the trade name Boltorn® from the company Perstorp AB, hyper-branched polyesters as well as the hyper-branched polyesteramides obtainable under the trade name Hybrane® from the company DSM BV, Netherlands. Another example for a hyper-branched polymer is a polyglycerine polymer with the classification PG-2, PG-5 and PG-8 of the company Hyperpolymers GmbH. Polyethylenimines with the classification PEI-5 and PEI-25 from the company Hyperpolymers GmbH are other examples of hyper-branched polymers.

It is further preferred for the hyper-branched polymers used as additives in the process according to the invention to have, besides the previously mentioned melting point and vapour pressure, at least one, most preferably all of the following properties:

(α1) a M_{W}/M_{N} ratio, determined by means of gel permeation chromatography after MALDI-TOF (DIN 55 672), in a range from about 1 to about 20, particularly preferably in a range from about 1.1 to about 10 and even more preferably in a range from about 1.2 to about 5, wherein MW is the weight average molecular weight and MN is the number average molecular weight;

(α2) a weight average molecular weight MW, determined by means of gel permeation chromatography after MALDI-TOF (DIN 55 672), in a range from about 100 to about 100,000 g/mol, particularly preferably in a range from about 500 to about 10,000 g/mol and even more preferably in a range from about 1,000 to about 5,000 g/mol;

(α3) a viscosity according to DIN 53 019 at 20° C. in a range from about 1 to about 10,000 mPa×sec, preferably from about 2 to about 5,000 mPa×sec, particularly preferably in a range from about 5 to about 1,000 mPa×sec and even more preferably in a range from about 10 to about 500 mPa×sec;

(α4) the hyper-branched polymer or mixture thereof is stable up to a temperature of about 100° C., particularly preferably up to a temperature of about 150° C., more preferably up to a temperature of up to about 200° C. and further preferred up to a temperature of about 300° C., whereby the term “stable” is interpreted as meaning that up to the respective temperature no decomposition of the polymer is observable by gas chromatography, for example by formation of gaseous breakdown products, in particular carbon dioxide or water, up to a limit of under about 1 ppm, preferably of under about 0.1 ppm and particularly preferably about 0.01 ppm.

Preferred embodiments of the hyper-branched polymer result from the individual properties and from combinations of at least two of these properties. Particularly preferred hyper-branched polymers are polymers characterized by the following properties or combinations of properties respectively: α1, α2, α3, α4, α1α2, α1α3, α1α4, α2α3, α2α4, α3α4, α1α2α3, α1α2α4, α1α3α4, α2α3α4, α1α2α3α4.

iii. Mixtures of Ionic Liquids and Highly Branched Polymers

In a preferred embodiment of the process according to the invention, a pure ionic liquid or a pure highly branched polymer is used as an additive. According to another embodiment the use of a mixture of at least about 2 different ionic liquids or of at least about 2 different highly branched polymers is preferred. Mixtures of an ionic liquid and a highly branched polymer can also be used as an additive.

The additives used in the process according to the invention, in particular the ionic liquids, are preferably characterized in that when they are brought into contact with a two-component system comprising about 60 wt. % water and about 40 wt. % acrylic acid, the separation factor at a pressure of about 1 bar and a temperature of about 95° C. with respect to the pure two-component system of water and acrylic acid is increased to a value of at least about 29%, preferably to at least about 100% and more preferably to at least about 200%, wherein the increase of the separation factor is defined as follows:
Increase of the separation factor [%]=100×[separation factor with additive−separation factor without additive)/separation factor without additive].

The determination of the separation factor thus occurs by combined headspace/gas chromatographical and WLC analysis according to the process described in Verhahrenstechnik 1974, 8, pages 343-347. The separation factor is defined in Destillation Design, Henry Z. Kister, 1992, pages 3ff.

Furthermore, the additives used in the process according to the invention, in particular the ionic liquids or the highly branched polymers, are preferably characterized in that they are sufficiently miscible with at least one component of the composition Z to form a solution. It is thus preferred according to the invention that at a temperature of about 20° C. and a pressure of about 1013 mbar at least about 0.2 g, particularly preferably about 0.4 g and even more preferably at least about 0.6 g of the additive, preferably of the ionic liquid or of the highly branched polymer, are miscible with a gram of composition z, without a phase separation occurring between the additive, preferably the ionic liquid or the highly branched polymer, and the (meth)acrylic acid-comprising to composition.

In general the compositions Z have, besides a monomer, at least one impurity. In an embodiment according to the invention, it is preferred that in the process according to the invention the additive brought into contact with the composition Z shows an “affinity” for the monomer, which is higher than the affinity for at least one impurity. By “affinity” is understood an ionic interaction, a dipole-dipole interaction or a Van der Waals interaction, wherein in the following a high affinity “system” can arise comprising the additive and the monomer or the at least one impurity, which exists for example as an aggregate or a complex of an additive and the monomer or the at least one impurity. In this embodiment the additive with the monomer form an SM system, which is separated from the composition Z and thereby from the at least one impurity and optionally then separated into the monomer and the additive, wherein it is preferred to conduct the additive back into the composition Z directly or indirectly, for example via a further purification step to which the additive can be subjected.

In another embodiment according to the invention, it is preferred that the additive brought into contact with the composition Z in the process according to the invention shows an affinity for at least one impurity, which is higher than the affinity for the monomer. In this embodiment the additive with the at least one impurity or a mixture of two or more impurities form an SV system, which can be separated from the composition Z and thereby from the monomer and optionally then separated into the at least one impurity or a mixture of two or more impurities on the one hand and the additive on the other hand, wherein it is preferred to conduct the additive back into the composition Z directly or indirectly, for example via a further purification step to which the additive can be subjected.

In a further embodiment of the process according to the present invention, the separating phase is used in an extraction process. Herein an E-multiphase system forms from the separating phase during the extraction process. It is here preferred that the monomer is more concentrated in one phase of the E-multiphase system than in the other phase or phases of the E-multiphase system. The term “extraction” according to the present invention is understood to include adsorption and absorption. In this context gas wash, absorption of liquids by solids and the like can be used.

According to another embodiment of the process according to the present invention, the separating phase is used in a distillation process. In this case a D-multiphase system forms during the distillation process from the separating phase. It is here preferred that the monomer is more concentrated in one phase of the D-multiphase system than in the other phase or phases of the D-multiphase system.

According to a further embodiment of the process according to the present invention, the separating phase is used in a crystallization process. Thus during the crystallization process a K-multiphase system forms from the separating phase, which has at least one solid crystal phase. It is here preferred that the monomer is more concentrated in one phase of the K-multiphase system, preferably the crystal phase, than in the other phase or phases of the K-multiphase system.

According to another embodiment of the process according to the present invention, the separating phase forms in a separating process working with a membrane. In this case a M-multiphase system forms during the membrane separation from the separating phase. It is here preferred that the monomer is more concentrated in one phase of the M-multiphase system than in the other phase or phases of the M-multiphase system. In the context of the use of a membrane it is preferred that the additive is at least partially worked into the membrane. In this context reference is made to the article of Luis C. Branco, Angewandte Chemie 2002, 114, No. 15, pages 2895ff.

All processes known to the skilled person and appearing suitable can be considered as extraction, distillation or crystallization processes. In the context of the crystallization, layer or suspension crystallization are preferred, whereby suspension crystallization is particularly preferred. In this context reference is made to WO 02/055469 A1.

The variants and process forms described in the above embodiments of the process according to the invention can be used singly or in combination. In this case the serial consecutiveness of variants forming at least two similar systems is particularly preferred. Process forms can furthermore occur in different variants.

In the process according to the invention, as composition Z a composition is preferably used, which is obtained in the course of the synthesis of (meth)acrylic acid by oxidation of propylene or isobutylene in the gas phase. In this context the following compositions are preferred as (meth)acrylic acid-comprising composition ZA, with which the above-described additive is brought into contact:

(β1) the gaseous composition ZA1, which is obtained as reaction mixture by heterogeneously catalyzed gas phase oxidation of propylene or isobutylene with oxygen, taking place at a solid state catalyst, at temperatures preferably between about 40 and about 400° C., in the case of the oxidation of propylene preferably in two steps via acrolein as intermediate,

(β2) the composition ZA2, which is obtained as (meth)acrylic acid-comprising, high boiling solvent mixture, if the gaseous reaction mixture obtained after the heterogeneously catalysed gas phase oxidation of propylene or isobutylene with oxygen taking place at a solid state catalyst at temperatures preferably between about 40 and about 400° C. is absorbed with a mixture of high boiling solvents by counter-current absorption;

(β3) the composition ZA3, which is obtained as aqueous (meth)acrylic acid solution, if the gaseous reaction mixture obtained after the heterogeneously catalyzed gas phase oxidation of propylene or isobutylene with oxygen at a solid state catalyst at temperatures preferably between about 40 and about 400° C. is preferably condensed in a direct condenser;

(β4) the composition ZA4, which is obtained as (meth)acrylic acid-comprising solvent in the homogeneously catalyzed liquid phase oxidation of propylene or isobutylene with oxygen at a catalyst dissolved or dispersed in a solvent, preferably in water, at temperatures preferably between about 40 and about 500° C. and at pressures between about 1 and about 200 bar;

(β5) the composition ZA5, which is obtained as a (meth)acrylic acid-comprising phase which is depleted or enriched, preferably enriched, in (meth)acrylic acid, if the (meth)acrylic acid-comprising, high boiling solvent mixture according to (β2), the aqueous (meth)acrylic acid solution according to (β3) or the (meth)acrylic acid-comprising solvent according to (β4) is processed in a further process step by a separation process requiring energy input, preferably by distillation or rectification;

(β6) the composition ZA6, which is obtained as a (meth)acrylic acid-comprising phase which is depleted or enriched, preferably enriched, in (meth)acrylic acid, if the (meth)acrylic acid-comprising, high boiling solvent mixture according to (β2), the aqueous (meth)acrylic acid solution according to (β3) or the (meth)acrylic acid-comprising solvent according to (β4) is processed in a further process step by a separation process requiring no energy input, preferably by extraction or crystallization;

(β7) each composition ZA7, which is obtained as a more concentrated (meth)acrylic acid-comprising composition with respect to the (meth)acrylic acid, if the (meth)acrylic acid-comprising, high boiling solvent mixture according to (β2), the aqueous (meth)acrylic acid solution according to (β3) or the (meth)acrylic acid-comprising solvent according to (β4) is processed in a further process step by combination of a separation process requiring energy input and a separation process not requiring energy input, preferably by a combination of distillation or crystallisation.

Embodiments herein of the process according to the invention can likewise be used in the processing of composition Z accumulating in column bottoms and other bottoms.

By “requiring energy input” is understood according to the present invention to be the input of thermal energy but not the input of mechanical energy such as stirring.

In a preferred embodiment of the process according to the invention for separation of acrylic acid from acrylic acid-comprising compositions Z there is an acrylic acid-comprising composition ZAA selected from the compositions ZA1 to ZA7 defined in variants (β1), (β2), (β3), (β4), (β5), (β6) or (β7). In this case the acrylic acid-comprising composition ZAA is preferably based on ZAA components:

(γ1) from about 5 to about 99.994 wt. %, particularly preferably from about 10 to about 99.4 wt. % and even more preferably from about 50 to about 97 wt. % monomeric acrylic acid, and as impurity

(γ2) at least about 0.001 wt. %, particularly preferably at least about 0.1 wt. % and even more preferably at least about 0.5 wt. % of at least one acrylic acid oligomer, preferably acrylic acid dimers and acrylic acid trimers,

(γ3) at least about 0.001 wt. %, particularly preferably at least about 0.1 wt. % and even more preferably at least about 0.5 wt. % acetic acid,

(γ4) at least about 0.001 wt. %, particularly preferably at least about 0.1 wt. % and even more preferably at least about 0.5 wt. % propionic acid,

(γ5) at least about 0.001 wt. %, particularly preferably at least about 0.1 wt. % and even more preferably at least about 0.5 wt. % of at least one aldehyde,

(γ6) at least about 0.001 wt. %, particularly preferably at least about 0.1 wt. % and even more preferably at least about 0.5 wt. % maleic acid or maleic acid anhydride,

(γ7) at least about 0.001 wt. %, particularly preferably at least about 0.1 wt. % and even more preferably at least about 0.5 wt. % of at least one by-product which is preferably different from the components (γ1) to (γ6) and either accumulates in the gas phase oxidation of propylene and/or the subsequent processing of the gaseous reaction mixture or is added as other components, for example as catalysts, as well as

(β8) a residual quantity of a fluid, preferably water or high boiling solvent, in particular diphenyl ether or diphenyl, or mixtures of at least two thereof,

wherein the sum of the components (γ1) to (γ8) amounts to 100 wt. %.

It is furthermore preferred in the process according to the invention that at least one, preferably two and particularly preferably all the ZAA components apart from γ1 are depleted, according to the separation of the acrylic acid in the process according to the invention compared to the composition ZAA, by at least about 0.1 wt. %, preferably at least about 1 wt. % and particularly preferably at least about 10 wt. % with respect to the content of the respective ZAA components.

It is particularly preferred according to the invention that the composition Z comprises monomer in a quantity in a range from about 5 to about 99.999 wt. %, particularly preferably in a quantity in a range from about 20 to about 99 wt. % and even more preferred in a quantity in a range from about 40 to about 80 wt. %, respectively based on the total weight of the composition Z. It is furthermore preferred that the composition Z comprises at least about 0.001 to about 90 wt. %, preferably about 1 to about 80 wt. % and particularly preferably from about 10 to about 70 wt. % water, respectively based on the total weight of the composition Z.

The bringing of the composition Z into contact with the additive occurs if the composition Z is a fluid under the temperature and pressure conditions during the bringing into contact, by simple mixing of both components, preferably by mixing by means of a suitable stirring device, preferably a static mixer or in a counter-flow or both. If the composition Z is a solid under the temperature and pressure conditions during the bringing into contact, this is either converted into a liquid by increasing the temperature to the melting point and then mixed with the additive, or the solid is brought into contact in the solid state with the additive, which is preferably liquid under the temperature and pressure conditions during the bringing into contact.

In the case of the extraction, the temperature of the additive and of the composition Z lies during the bringing into contact preferably in a range from about −20 to about 200° C., particularly preferably in a range from 0 to about 150° C. and even more preferably in the range from about 10 to about 100° C. The pressure during the bringing into contact lies preferably in a range from about 0.001 to about 100 bar, particularly preferably in a range from about 0.01 to about 50 bar and even more preferably in the range from about 0.1 to about 10 bar.

In the case of the distillation, the temperature of the additive and of the composition Z lies during the bringing into contact preferably in a range from 0 to about 300° C., particularly preferably in a range from about 10 to about 250° C. and even more preferably in the range from about 20 to about 200° C. The pressure during the bringing into contact lies preferably in a range from about 0.0001 to about 100 bar, particularly preferably in a range from about 0.001 to about 10 bar and even more preferably in the range from about 0.01 to about 2 bar.

In the case of the crystallization, the temperature of the additive and of the composition Z lies during the bringing into contact preferably in a range from about −100 to about 200° C., particularly preferably in a range from about −50 to about 100° C. and even more preferably in the range from about −30 to about 100° C. The pressure during the bringing into contact lies preferably in a range from about 0.0001 to about 100 bar, particularly preferably in a range from about 0.001 to about 10 bar and even more preferably in the range from about 0.01 to about 2 bar.

In a preferred embodiment of the process according to the invention the additive is brought into contact with the composition Z preferably in a quantity in a range from about 0.01 to about 95 wt. %, particularly preferably in a quantity in a range from about 10 to about 80 wt. % and even more preferably in a quantity in a range from about 20 to about 70 wt. %, respectively based on the total weight of additive and composition Z.

The separation of the monomer from the composition Z which has been brought into contact with the additive occurs by means of separation processes known to the skilled person. Thus processes of separation into the monomer with energy input, for example by heating, in particular evaporation, distillation, rectification or extractive rectification, are particularly preferred. All distillation columns known to the skilled person can be used in the distillation. A column with sieve plates, for example Dual-Flow plates or cross-flow sieve plates out of metal, is preferably used. For the rectification and extractive rectification, for example packed columns, plate columns or packing columns can be used. Suitable plate columns are those with Dual-Flow plates, bubble plates or valve trays. The reflux ratio can for example amount to about 1 to about 10.

In the use of processes with energy input it is preferred according to the invention that the separation of the (meth)acrylic acid from the (meth)acrylic acid-comprising composition which has been brought into contact with the additive occurs preferably at a temperature in a range from about 20 to about 300° C., particularly preferably in a range from about 30 to about 250° C. and even more preferably in a range from about 40 to about 200° C. and at a pressure in a range from about 0.0001 to about 100 bar, particularly preferably in a range from about 0.001 to about 10 bar and even more preferably in a range from about 0.1 to about 2 bar.

Besides these separating processes requiring energy input, the separation of the monomer from the monomer-comprising composition which has been brought into contact with the additive can also occur by extraction or by static or dynamic crystallization processes. All crystallizers known to the skilled person and suitable according to the invention can be used as crystallizer. Layer and suspension crystallizers fall into this category. In suspension crystallization preferably boiler crystallizers, scratch crystallizers, cold disc crystallizers, crystallizer snails, drum crystallizers and the like can be used, wherein the suspension crystallizer is preferably operated with a downstream wash column. In this context reference is made to the disclosure of WO 99/14181.

For the extraction, columns without energy input are particularly suitable, wherein spray, packed or sieve-plate columns are preferred. Another suitable group according to the invention is presented by pulsed columns, wherein spray, packed, Prochazaka, Karr or sieve-plate columns are preferred. Columns with rotating parts can also be used. In this context Scheibel, KUhni, RDC, ARD columns, RZ or SHE extractors should be mentioned.

In another particular embodiment of the process according to the invention separation processes requiring energy input and separation processes not requiring energy input can be combined. It is thus conceivable that a composition Z is first brought into contact with the additive and then the monomer is separated by distillation. The thus separated monomer can then be brought into contact with the additive again in a further process step. The monomer is then separated from the thus obtained composition by crystallization in the presence of the additive. The individual separation processes requiring and not requiring energy input can be repeated individually or in combination any number of times after addition of the additive to the concentrated monomer. Molfilters can for example be used for this.

In a preferred embodiment of the process according to the invention, the additive is recycled. In this way an extremely economical carrying out of the process according to the invention is possible.

After the separation of the monomer from the composition Z which has been brought into contact with the additive, the additive preferably remains together with other by-products and optionally not yet separated monomer in the phase which is depleted with respect to the monomer. If the separation of the monomer occurs by separation processes requiring energy input, for example by distillation, the additive remains as bottom product preferably together with other by-products and optionally not yet separated monomer. If the separation of the (meth)acrylic acid occurs by separation processes not requiring energy input, such as for example by crystallization, the additive preferably remains in the mother liquor.

In order to be able to recycle the additive in the process according to the invention, a purification of the additive by separation from the by-products and optionally not yet separated monomer is advantageous. This separation can occur in the same way as the previously described separation of the monomer from the composition Z which was brought into contact with the additive, by separation processes requiring and not requiring energy input, wherein the preferred separation processes requiring and not requiring energy input are those which have already been described. A combination of separation processes requiring and not requiring energy input, for example an initially carried out distillation and a subsequent crystallization of the residue of the distillation can also lead to purification of the additive. A purification of the additive by evaporation, by desorption with inert gas, by crystallization, e.g. melt crystallization, by extraction, e.g. with supercritical media such as supercritical carbon dioxide is particularly preferred, by electrolysis or by chromatography.

Particularly preferably the separation of by-products and not yet separated (meth)acrylic acid from the additive occurs by simple evaporation at a temperature in a range from about 10 to about 300° C., particularly preferably at a temperature in a range from about 20 to about 250° C. and even more preferably at a temperature in a range from about 30 to about 200° C. and at a pressure in a range from about 0.0001 to about 100 bar, particularly preferably in a range from about 0.001 to about 10 bar and even more preferably in a range from about 0.1 to about 2 bar.

The recycling of the additive after separation of the monomer from the composition Z results in a concentration of the additive, since a constant enrichment of by-products results from the addition of additive contaminated with these by-products.

The recycled additive is preferably fed back into the process according to the invention in a quantity such that the fraction of recycled additive lies in a range from about 10 to about 100 wt. %, particularly preferably in a range from about 30 to about 99.5 wt. % and even more preferably in a quantity in a range from about 60 to about 98 wt. %, respectively based on the total weight of the additive used in the process according to the invention.

It furthermore corresponds to an embodiment such that in the process according to the invention at least one, preferably at least 2 and particularly preferably at least 3 and even more preferably at least 5 impurities can be depleted. It is additionally preferred that the depletion occurs by at least about 10%, preferably at least about 50% and particularly preferably at least a factor of about 10, respectively based on the concentration of the impurity in comparison to the monomer.

The device according to the invention for synthesis of a monomer defined according to the invention comprises the following components in fluid-conducting assembly:
(δ1) a monomer synthesis unit (1) comprising a gas phase monomer synthesis unit (1a) with a quench unit (2) following the gas phase monomer synthesis unit (1a), or
(δ2) a liquid phase monomer synthesis unit (1b),
(δ3) optionally a first purification unit (3) following the liquid phase monomer synthesis unit (1b) or the quench unit (2),
(δ4) a first monomer separation unit (4), comprising as components:
   (δ4_{—}1) a conduit for a monomer-comprising composition Z (5) connected with the liquid phase monomer synthesis unit (1b) or with the quench unit (2) or with the optionally present first purification unit (3),
   (δ4_{—}2) an additive conduit (6),
   (δ4_{—}3) a contact region (7) which receives said monomer-comprising composition conduit (5) and the additive conduit (6),
   (δ4_{—}4) a conduit (8) exiting the contact region (7) for separated monomer.

In a further embodiment of the device according to the invention the device additionally comprises in the monomer separation device (4)

(δ4_{—}5) a separating element (14) connected in fluid-conducting manner with the contact region (7).

In another embodiment of the device according to the invention the device comprises, in the monomer separation device (4), in addition to (δ4_{—}5)

(d4_{—}6) a further monomer separation unit (10) connected with the first monomer separation unit (4) or further purification unit or both.

According to a further embodiment of the device according to the invention the device comprises as further component (δ5) a recycling unit (12) for said additive, which in turn comprises:

(δ5_{—}1) a feed line (13) for a composition comprising said additive, which is connected in fluid-conducting manner to a separating element (14),

(δ5_{—}2) exiting said separating element (14), an outlet (15) for said additive, which is connected in fluid-conducting manner to said additive conduit (6) or to said contact region (7),

(δ5_{—}3) exiting said separating element (14), an outlet (16) for the monomer, which is connected in fluid-conducting manner with said conduit (8).

In the device according to the invention, distillation columns, extraction mixers or crystallization devices can be used as contact region (7). In the contact region (7) preferably a separation phase is formed, which here or later breaks down into at least 2 separation components, for example crystals on the one hand and additive and optionally impurity-comprising mother liquor on the other.

All columns which for the skilled person are matched to and suitable for the monomer to be purified and for the process according to the invention can be considered as distillation columns. The previously mentioned types are preferred.

All mixers which for the skilled person are matched to and suitable for the monomer to be purified and for the process according to the invention can be considered as extraction mixer. Static and dynamic mixers fall into this category. In this context reference is made to the disclosure of WO 99/14181 and WO 02/055469.

All crystallizers which for the skilled person are matched to and suitable for the monomer to be purified and for the process according to the invention can be considered as crystallization devices. In this context, layer crystallizers and suspension crystallizers combined with a wash column are preferred in addition to those previously described.

The chemical products according to the invention are at least based on or comprise the (meth)acrylic acid obtainable by the process according to the invention. The chemical products comprise fibers, formed bodies, films, foams, superabsorbent polymers, special polymers for the areas of waste water treatment, dispersion dyes, cosmetics, textiles, leather processing or paper manufacture, or detergents or hygiene articles.

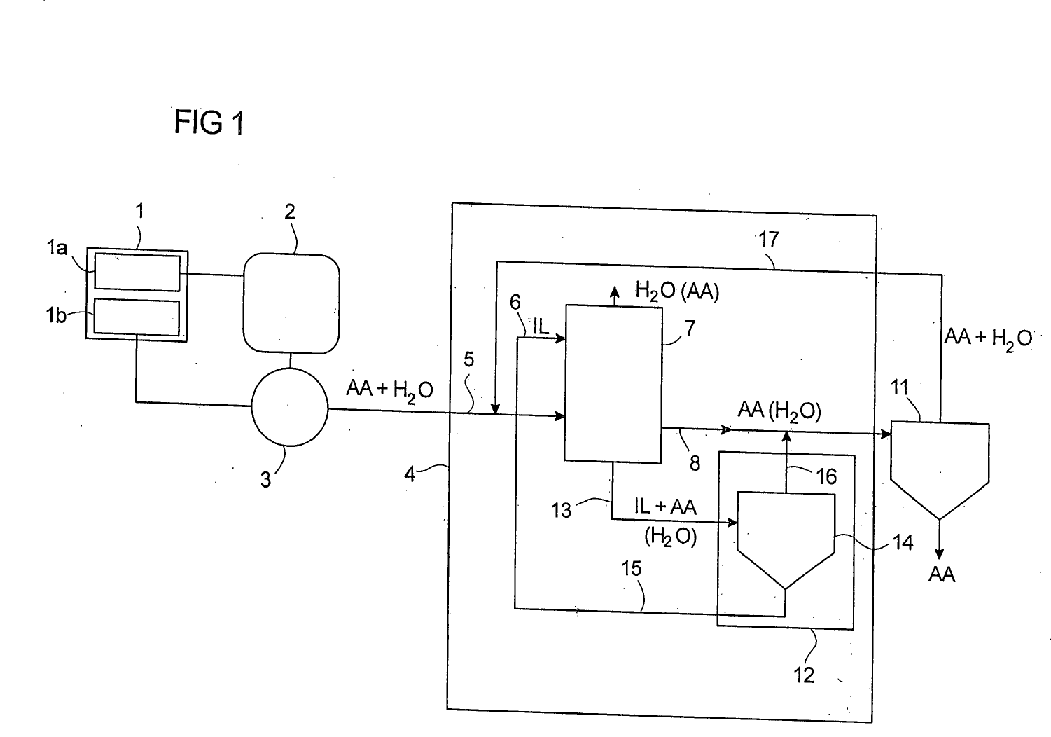

According to FIG. 1, (meth)acrylic acid is synthesised as a monomer according to the invention in the monomer synthesis unit 1. The monomer synthesis unit 1 can in this case be a gas phase monomer synthesis unit 1a or a liquid phase monomer synthesis unit 1b. A quench unit 2 follows the monomer synthesis unit 1, the quench unit 2 being connected with the gas phase monomer synthesis unit 1a. The aqueous (meth)acrylic acid solution obtained in the quench unit 2 or in the liquid phase monomer synthesis unit lb is purified in a first purification unit 3, for example a distillation column. The thus-purified (meth)acrylic acid solution then passes via the conduit 5 into the (meth)acrylic acid separation unit 4. It is however likewise possible to connect the liquid phase monomer synthesis unit 1 or the quench unit 2 directly with the (meth)acrylic acid separation unit 4 via the conduit 5. This comprises the conduit 5 for the aqueous (meth)acrylic acid solution, the conduit being connected with the corresponding preceding parts. Via this conduit 5, the aqueous (meth)acrylic acid solution passes into the contact region 7. The additive passes into the contact region 7 via the additive conduit 6. The additive can come from a reservoir, which is not depicted, or from a recycling unit 14. In this embodiment of the device according to the invention, after the contact of additive and aqueous (meth)acrylic acid solution, the separation of the (meth)acrylic acid occurs via conduit 8. The separated (meth)acrylic acid, which is mostly accompanied by some water, is concentrated in a further purification unit 11. The composition remaining in the mixing vessel comprising the additive, optionally further impurities and not yet separated (meth)acrylic acid is conducted via conduit 13 to the recycling unit 12. It passes there into a separating element 14, in which a concentration of the additive occurs and optionally further impurities present are separated from the additive mostly by suitably purification methods. The concentrated additive passes via the outlet 15 into the mixing vessel 7, the (meth)acrylic acid separated during the concentration of the additive passes via an outlet 16 into the conduit 8 and via this into the separating element 11. The phase depleted with respect to (meth)acrylic acid and obtained in the separating element 11 can be conducted via conduit 17 to conduit 5.

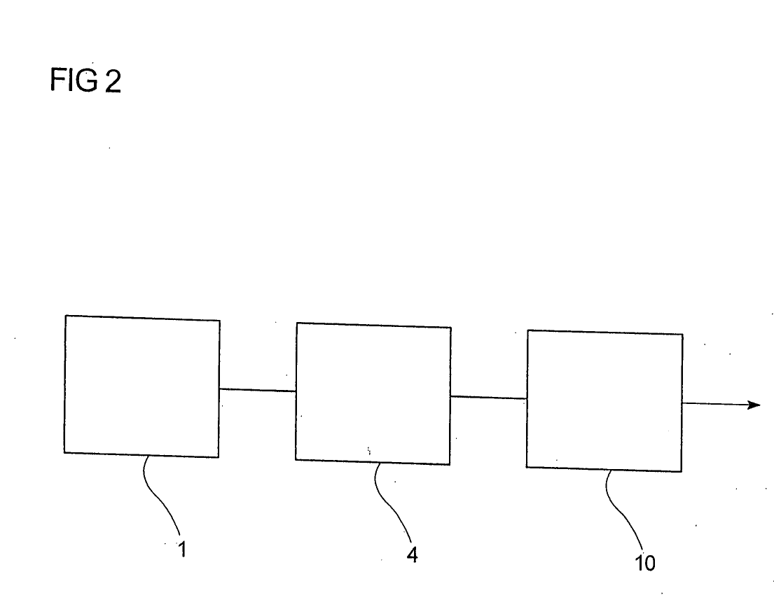

In FIG. 2 the monomer synthesis unit 1 is followed by a first monomer separation unit 4, which is in turn followed by a further monomer separation unit 10 according to the invention. Further purification units or also further processing units such as a synthesis unit for water absorbing polymers can connect hereto.

Test Methods

1. Melting Point

The melting point determination occurs in a so called melting point tube. The substance sample is placed into a glass tube, which has one side sealed by melting and an inner diameter of approximately 1.0 to 1.5 mm and length approximately 7 to 8 cm (melting tube, melting point capillary), to a height of approximately 3 to 5 mm according to Thile (Organikum Organisch Chemisches Grundpraktikum, 16^{th} Edition, 1986, VEB Verlag der Wissenschaften, pages 73, 74).

After introducing the substance at the top end of the capillary, the sample is carefully tapped so that it passes to the bottom. The filled melting point tube is then slowly heated and the temperature at which the substance sample melts determined.

2. Vapour Pressure

By means of effusion methods with vapour pressure scales according to guidelines 92/69/EWg from 31.07.1992 (Official Journal A.04. of the European Community).

### EXAMPLES

### Example 1

### Extraction

In a 350 ml double-walled mixing vessel maintained at 50° C. with water, was placed a quantity of 250 ml of a “feed” as given in Table 1 which was stirred vigorously for 1 minute. After ending the stirring, phases formed, the composition of which is likewise given in Table 1. After a sedimentation time of 1 minute the compositions of the phases were determined by titration of the acrylic acid with NaOH solution and determination of the amount of water according to Karl Fischer and the Boltorn® quantity by calculation.

TABLE 1

| | | Acrylic acid | Boltorn ® H 3200 |
|---|---|---|---|
| | Water [wt. %] | [wt. %] | [wt. %] |
| Feed 1 | 40 | 20 | 40 |
| Lower Phase 1 | 69 | 30 | 1 |
| Upper Phase 1 | 9 | 14 | 83 |
| Feed 2 | 40 | 40 | 20 |
| Lower Phase 2 | 51 | 48 | 1 |
| Upper Phase 2 | 6 | 11 | 83 |
| Feed 3 | 20 | 60 | 20 |
| Lower Phase 3 | 25 | 74 | 1 |
| Upper Phase 3 | 4 | 13 | 83 |

Boltorn ® H 3200 is a hyper-branched polymer which can be produced and obtained from the company Perstorp GmbH.

### Example 2

### Extraction

Three ionic liquids (the products OMA-HSO₄, OMA-MeSO4 and OMP-HSO4, obtainable from the company solvent Innovation GmbH, Cologne, Germany) were tested with respect to their extraction effect on acrylic acid in aqueous solution. Thus respectively quantities of 50.0 g acrylic acid, 50.0 g dist. Water and 30.0 g of the ionic liquid were weighed into a 250 ml conical flask and mixed intensively using a magnetic stirrer over a period of 2 hr. The mixture was then transferred into a 250 ml separating funnel and the separating funnel was allowed to stand overnight in order to give the mixture time to form a phase separation. The following morning, the phases were separated, weighed and analyzed. The acrylic acid content was determined by HPLC, the water content by Karl-Fischer titration and the ionic liquid content determined, depending on the central atom in the ionic liquid, by elemental analysis for respectively nitrogen or phosphorus in both phases.

TABLE 2
trioctylmethylammonium hydrogensulfate (OMA-HSO4)

| | | | OMA-HSO4 |
|---|---|---|---|
| | Acrylic acid [wt. %] | water [wt. %] | [wt. %] |
| Reactant | 38.4 | 38.5 | 23.1 |
| Heavy phase | 33.0 | 63.7 | 3.3 |
| Light phase | 50.0 | 2.5 | 47.5 |
| Distribution | 1.515 | 0.039 | 14.394 |
| coefficeint | | | |

TABLE 3
trioctylmethylammonium methylsulfate (OMA-MeSO4)

| | Acrylic acid | | OMA-MeSO4 |
|---|---|---|---|
| | [wt. %] | water [wt. %] | [wt. %] |
| Reactant | 38.4 | 38.5 | 23.1 |
| Heavy phase | 37.0 | 62.1 | 0.9 |
| Light phase | 43.0 | 4.4 | 52.6 |
| Distribution | 1.162 | 0.071 | 59.101 |
| coefficeint | | | |

TABLE 4
trioctylmethylphosphonium-hydrogensulfate (OMP-HSO4)

| | | | OMP-HSO4 |
|---|---|---|---|
| | Acrylic acid [wt. %] | water [wt. %] | [wt. %] |
| Reactant | 38.4 | 38.5 | 23.1 |
| Heavy phase | 38.0 | 65.0 | 0.7 |
| Light phase | 48.0 | 16.6 | 41.0 |
| Distribution | 1.263 | 0.256 | 58.571 |
| coefficeint | | | |

The experiments show that the first ionic liquid (OMA-HSO4) extracts acrylic acid most effectively into the phase of the ionic liquid (light organic phase) (larger distribution coefficient D; D=(mᵢ^{organic}/mₜₒₜₐₗ^{organic})/(mᵢ^{aq. Phase}/mₜₒₜₐₗ^{aq phase}) The separation to D=1, at which the respective components are distributed equally over both phases, is always decisive for judging the distribution coefficient. For water, values smaller than 1 are particularly preferred.) For this reason the loss of ionic liquid into the heavy aqueous liquid are largest for the first ionic liquid (smaller distribution coefficients compared to the other two ionic liquids).

### Example 3

### Crystallization

250 g of the “feed” detailed in Table 5 with a temperature of 20° C. were weighed into a 350 ml double-walled stirring vessel, which was maintained at −15° C. using a mixture of ethylene glycol and water, and cooled to −15° C. with a temperature ramp of 0.5 K/minute. At −10° C. formation of crystals was observed. The mother liquor with the composition given in Table 5 was separated from the crystals by means of a vacuum suction filter. 142 g of crystals of the composition given in Table 5 were obtained. The compositions were determined as in Example 1.

TABLE 5

| | | | ECOENG ® 500 |
|---|---|---|---|
| | Water [wt. %] | Acrylic acid [wt. %] | [wt. %] |
| Feed | 70 | 10 | 20 |
| Crystals | 87 | 4 | 9 |
| Mother liquor | 49 | 13 | 18 |

ECOENG ® 500 is a hyper-branched polymer which can be produced and obtained from the company Solvent Innovation GmbH, Cologne, Germany.

### Example 4

### Crystallization

70 g high purity acrylic acid and 70 g distilled water were placed in a temperature-controllable stirred double-walled vessel with a capacity of 200 ml with 55 g N-ethyl-methyl-diiso-propyl ammonium hydrogensulfate (EMPAH, from the company Solvent Innovation GmbH, Cologne, Germany). The composition of the compounds is shown in Table 6. The mixture was cooled to −12° C., whereby the first crystals precipitated. The mixture was then further cooled to −17.2° C. The content of the vessel was filtered using a vacuum filter and the filtrate analyzed. The damp crystals were spun dry in a laboratory centrifuge at 4,000 rpm and then analyzed. The composition of the filtrate and the dry crystals is shown in Table 6. The analysis was made by HPLC (acrylic acid), Karl-Fischer titration (water) and elemental nitrogen analysis (EMPAH).

TABLE 6

| | water [wt. %] | Acrylic acid [wt. %] | EMPAH [wt. %] |
|---|---|---|---|
| Reactant | 35.9 | 35.9 | 28.2 |
| Crystals | 3.38 | 95.0 | 1.6 |
| Mother liquor | 43.4 | 26.0 | 27.0 |

In Table 7, the results of an experiment with 1,3-dimethylpyridinium hydrogensulfate (DMPH, from the company Solvent Innovation GmbH, Cologne, Germany) in the place of EMPAH are given. The crystallization and end temperatures were −18° C. and −22.6° C. The experiment and the analysis were carried out as previously in the context of the crystallization in the presence of EMPAH.

TABLE 7

| | water [wt. %] | Acrylic acid [wt. %] | DMPH [wt. %] |
|---|---|---|---|
| Reactant | 35.9 | 35.9 | 28.2 |
| Crystals | 4.64 | 94.0 | 2.1 |
| Mother liquor | 46.8 | 24.0 | 26.5 |

The examples show the possibility of crystallizing acrylic acid from an acrylic acid-water mixture, in which acrylic acid and water are present in a relative weight ratio of 1:1. Water would normally crystallize out of such mixtures. By using ionic liquids the acrylic acid-water eutectic point is displaced such that an increase in the acrylic acid yield from the crystallization can be achieved.

### Example 5

### Distillation

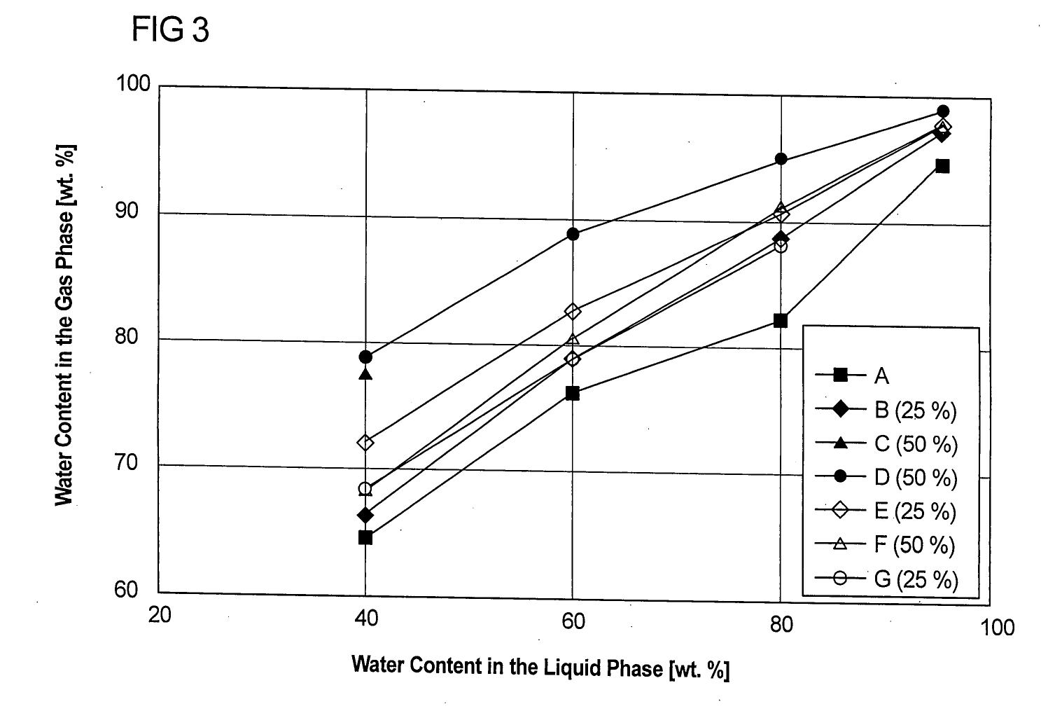

A 20 ml GC bottle with a septum cap with 5 ml of a mixture of composition Z and additive as given in Table 8 were heated to 95° C. in a heatable sample holder and a needle of a headspace gas chromatograph (Verfahrenstechnik 8, No. 12, pages 334-347, 1974) introduced into the gas space forming in the GC bottle. The composition of the gas accruing in the gas space was separated by gas chromatography and its composition determined via a thermal conductivity measurement; the composition is given in Table 8 and graphically displayed in FIG. 3.

TABLE 8

| Composition Z | | A | B | C | D | E | F | G |
|---|---|---|---|---|---|---|---|---|
| | Acrylic | Without additive | EMIM-BF₄ | HMIM-PF₆ | HMIM-BF₄ | Hybrane ® S 1200 | Polyglycerine PG-5 | Boltorn ® H 40 |
| Water conc. | acid conc. | (headspace GC) | (25 wt. %) | (50 wt. %) | (50 wt. %) | (25 wt. %) | (50 wt. %) | (25 wt. %) |
| [wt. %] | [wt. %] | Separation Factor | | | | | | |
| 40 | 60 | 2.82 | 3.00 | 4.34 | 5.38 | 3.80 | 3.29 | 3.31 |
| 60 | 40 | 2.16 | 2.52 | — | 5.34 | 3.12 | 2.77 | 2.49 |
| 80 | 20 | 1.21 | 1.96 | — | 4.96 | 2.25 | 2.38 | 1.87 |
| 95 | 5 | 1.00 | 1.76 | — | 5.21 | 2.14 | 2.34 | — |

The following additives were used in the Examples of Table 8:
HMIM-BF₄ (1-hexyl-3-methylimidazolium tetrafluoroborate), ionic liquid, Solvent Innovation GmbH;
EMIM-BF₄ (1-ethyl-3-mehylimidazolium tetrafluoroborate), ionic liquid, Solvent Innovation GmbH;
HMIM-PF₆ (1-hexyl-3-methylimidazolium hexafluorophasphate), ionic liquid, Solvent Innovation GmbH;
Hybrane ® S1200 (2,5-furandione), diehydro-polymer with 1,1′-iminobis[2-propanol], CAS No. 362603-93-8, DSM B.V., hyper-branched polymer;
Polyglycerin PG-5, CAS No. 25722-70-7P, producer Hyperpolymers GmbH, hyper-branched polymer;
Boltorn ® H40, Perstorp GmbH, hyper-branched polymer.

### LIST OF REFERENCE CHARACTERS

1 monomer synthesis unit
1a gas phase monomer synthesis unit
1b liquid phase monomer synthesis unit
2 quench unit
3 purification unit
4 monomer/(meth)acrylic acid separation unit
5 conduit for monomer/(meth)acrylic acid-comprising composition
6 conduit for additive
7 contact region
8 conduit for separated monomer/(meth)acrylic acid
10 further monomer/(meth)acrylic acid separation unit
11 further purification unit
12 recycling unit
13 feed for additive-comprising composition
14 separating element
15 outlet for additive
16 outlet for monomer/(meth)acrylic acid
17 conduit for monomer/(meth)acrylic acid-depleted phase from purification unit 11
AA acrylic acid
IL additive (ionic liquid or hyperbranched polymer)

1. Process for separation of a monomer comprising at least one double bond from a composition Z comprising said monomer and at least one impurity which is different to said monomer, comprising the steps:
bringing said composition Z into contact with an additive, wherein said additive has
a melting point of at most 150° C. and
a vapour pressure of at most 1 mbar at a temperature of 20° C., by forming a separation phase as well as
separating said monomer from said separation phase.

2. Process according to claim 1, with said additive comprising at least
i. an ionic liquid or
ii. a highly branched polymer or
iii. a mixture of at least two thereof.

3. Process according to claim 2, wherein said highly branched polymer has at least 3 repeating units per molecule, each comprising at least three possible binding sites, wherein at least three of said repeating units are each attached via at least three possible binding sites to at least three other repeating units.

4. Process according to claim 2, wherein said highly branched polymer has at least 3 repeating units per molecule, which have respectively at least three possible binding sites, wherein at least three of said repeating units have at least two possible binding sites.

5. Process according to claim 2, wherein said ionic liquid is liquid at a temperature of 20° C. and has a viscosity in a range from 1 to 10,000 mPa×sec.

6. Process according to claim 1, wherein the separation of said monomer from said composition Z which has been brought into contact with said additive occurs by distillation or by extraction or crystallisation or a combination of at least two thereof.

7. Process according to claim 1, wherein said additive is brought into contact with said composition Z, said additive being in a quantity in a range from 0.01 to 95 wt. % based on the total weight of the additive and the composition Z.

8. Process according to claim 1, wherein said additive is recycled.

9. Process according to claim 8, wherein said recycling of said additive occurs by a separation step requiring energy input.

10. Process according to claim 1, wherein said monomer is (meth)acrylic acid.

11. Process according to claim 1, wherein said composition Z is an acrylic acid-comprising composition ZAA based on
(γ1) 5 to 99.994 wt. % monomeric acrylic acid, and as impuritiy
(γ2) at least 0.001 wt. % of at least one acrylic acid oligomer,
(γ3) at least 0.001 wt. % acetic acid,
(γ4) at least 0.001 wt. % propionic acid,
(γ5) at least 0.001 wt. % of at least one aldehyde,
(γ6) at least 0.001 wt. % maleic acid or maleic acid anhydride,
(γ7) at least 0.001 wt. % of at least one by-product which is different from the components (γ1) to (γ6) and
(γ8) a residual quantity of a fluid and
wherein the sum of the components (γ1) to (γ8) amounts to 100 wt. %.

12. Process according to claim 1, wherein at least one impurity is depleted.

13. A device for synthesis of a monomer comprising the following components in fluid-conducting assembly:
(δ1) a monomer synthesis unit (1) comprising a gas phase monomer synthesis unit (1a) with a quench unit (2) following said gas phase monomer synthesis unit (1a), or
(δ2) a liquid phase monomer synthesis unit (1b),
(δ3) optionally a first purification unit (3) following said liquid phase monomer synthesis unit (1b) or said quench unit (2),
(δ4) a first monomer separation unit (4), comprising as components:
(δ4_{—}1) a conduit for a monomer-comprising composition Z (5) connected with said liquid phase monomer synthesis unit (1b) or with said quench unit (2) or with said optionally present first purification unit (3),
(δ4_{—}2) an additive conduit (6),
(δ4_{—}3) a contact region (7) which receives said monomer-comprising composition conduit (5) and said additive conduit (6),
(δ4_{—}4) a conduit (8) exiting said contact region (7) for separated monomer.

14. Device according to claim 13, wherein said device comprises as further component (δ5) a recycling unit (12) for said additive, which in turn comprises the following components:
(δ5_{—}1) an inlet (13) for a composition comprising said additive, which is connected in fluid-conducting manner to a separating element (14),
(δ5_{—}2) exiting said separating element (14), an outlet (15) for said additive, which is connected in fluid-conducting manner to said additive conduit (6) or said contact region (7),
(δ5_{—}3) exiting said separating element (14), an outlet (16) for said monomer, which is connected in fluid-conduction manner with said conduit (8).

15. Use of an additive which has
a melting point of at most 100° C. at a pressure of 1 bar and
a vapour pressure of at most 1 mbar at 20° C.,
as separation aid for the separation of at least one monomer comprising at least one double bond from a monomer-comprising composition.

16. Monomer obtainable by a process according to claim 1.

17. Fibres, formed bodies, films, foams, water absorbing polymers, special polymers for the areas waste water treatment, dispersion dyes, cosmetics, textiles, leather processing or paper manufacture, detergents or hygiene articles, at least based on or comprising (meth)acrylic acid obtained by a process according to claim 1.

18. Use of (meth)acrylic acid obtainable by a process according to claim 1 in or for manufacture of fibres, formed bodies, films, foams, water absorbing polymers or hygiene articles, detergents or special polymers for the areas waste water treatment, dispersion dyes, cosmetics, textiles, leather processing or paper manufacture.
